(19) United States
(12) Patent Application Publication
(10) Pub. No.: US 2003/0098918 A1
(43) Pub. Date: May 29, 2003

(54) Imaging system using color sensors and tunable filters

(76) Inventor: Peter J. Miller, Newburyport, MA (US)

Correspondence Address: Martin B Pavane Esq, Cohen Pontani Lieberman & Pavane, Suite 1210, 551 Fifth Avenue, New York, NY, 10176, US

(21) Appl. No.: 09/578,882

(22) Filed: May 26, 2000

Related U.S. Application Data
(60) Provisional application No. 60/136,270, filed on May 27, 1999.

(51) Int. Cl. H04N 9/083

(52) U.S. Cl. 348/273; 348/342

(57) ABSTRACT

The present invention provides a color imaging system and a method to capture an accurate color image by use of a tunable filter tunable between two states and a color detector that records the light transmitted through the filter when the filter is in the first state and then in the second state.

### BACKGROUND OF THE INVENTION

1. Field of the Invention

The field relates to color imaging systems and particularly to the use of tunable filter elements together with color-sensitive detectors to provide enhanced color quality images, relative to such detectors alone.

2. Description of the Related Art

The majority of all color imaging is presently performed using mosaic type detectors, where an imaging photosensor such as a charge-coupled device (CCD), charge-injection device (CID), or CMOS detector array is tiled with red, green, and blue color filters in a Bayer pattern, in stripes, or in some other regular arrangement. These sensors acquire color images, but the color rendition is not always accurate for real-world samples. This is because the spectral response of the R, G, and B channels in the camera are not exactly matched to the tristimulus functions X, Y, and Z.

The latter functions represent the best known approximation to the standard human observer. Since the detector has color weightings that are not equal to those of the standard observer, nor to a linear combination of the standard observer functions, the image produced by the detector cannot be well-matched to the human eye's perception, no matter what linear algebraic steps are applied to the images. There simply is not enough information to do so, since the detector samples the colors with the wrong weighting of wavelengths, and one cannot determine what the colors actually were, after the fact.

Current technology does not provide means for matching the RGB spectral response to the tristimulus curves, or to a linear combination thereof. Instead, the spectral response is set by the available dyes used to form the mosaic pattern, in concert with the response of the sensor itself. Because the spectral response of the detector is mismatched to how the human eye perceives the scene, the color fidelity is degraded by the acquisition process.

Another approach is to use three photodetectors together with a trichroic prism which partitions the incident light amongst the detectors, which are aligned in precise mechanical registration so that there is correspondence between the locations of a given pixel in each of the three detectors. This arrangement similarly produces the wrong color distribution, because the spectral response of the red, green, and blue channels does not correspond to the tristimulus functions nor a linear combination thereof.

Farrell et. al. teach in U.S. Pat. No. 5,479,524 how to use an RGB scanner with a bank of filters to reduce colorimetric error. The object is scanned at least twice; with no filter in place for the first scan, and with a filter mechanically engaged in the optical path for subsequent scans. The first scan data is analyzed to determine which filter or filters would be optimal in the later scans, based on the rendering of known colors. From one or more scans taken with filters in the beam, augmented in some cases by the scan taken with no filter in the beam, an enhanced color image is obtained based on a correction matrix. This achieves a high degree of color fidelity, but it is only suitable for use with scanners or inert objects that can be kept fixed for the time required to complete two or more scans, along with the intervening analysis to determine what filter is optimum. Also, it requires the presence of samples with known color, in order to perform the analysis of which filter to use, and to derive the coefficients used in the correction matrix.

Tunable filters may be used in combination with monochrome imaging array sensors to obtain color images, by taking a first exposure with the filter in the red setting, then a second exposure with the filter in the green setting, then a third with the filter in the blue setting. It is possible to tailor the response of each filter setting so the overall system (filter plus monochrome detector) matches the tristimulus functions, and thus produces images with high color fidelity. It has the further benefit that spatial resolution is enhanced and aliasing is eliminated, because every pixel provides full color information, in contrast to a mosaic where several pixels are used to determine the color in a given region. Such an arrangement is described in my co-pending provisional patent application Serial No. 60/159,277, entitled “Colorimetric Imaging System”.

Typically the tunable filter involved is constructed using liquid crystal switches, and the overall filter requires a minimum of two, and more commonly three, liquid crystal cells. This approach has several problems. The filter has significant cost, complexity, and thickness. In addition, light loss in the filter is considerable. The result is lower transmission, which means the system is less sensitive and does not work as well in dim scenes.

Also, since the three exposures are taken in time-series, the various color planes are acquired at different times, leading to a stroboscopic effect on moving objects. This is termed “color blur”. Color blur is objectionable because it tends to produce brightly-hued edges on moving objects, an effect which is quite unparalleled in ordinary life. Its presence is consequently perceived as artificial and out-of-place.

Finally, nematic liquid crystal cells exhibit a fast turn-on response (0.1 ms or less) when voltage is applied, but a slow turn-off response (1 ms or more) when voltage is removed. Many liquid crystal filter designs require at least one slow turn-off response in the course of tuning from red to green to blue. Except for a few specialized (and expensive) high-speed models, common imaging detectors such as CMOS, CCD, and CID detectors take several milliseconds to read out. Since the detector must be read-out and the filter must be tuned between each successive exposure, the overall acquisition of a color image takes well in excess of 1 ms, making it impractical to use conventional flash lighting.

Thus, presently all systems that provide for color image capture suffer from a significant loss in color fidelity, or are incompatible with flash lighting, or suffer from at least one of the following limitations: excessive cost, thickness, and light loss in the optics.

### SUMMARY OF THE INVENTION

The invention consists of a tunable filter which produces two states, together with a detector which has an inherent color imaging capability, to provide significantly better color imagery than the detector can provide on its own. The improved color fidelity derives from the fact the filter produces two states, each with its own well-characterized spectral weighting function, through which the detector views the scene or through which the illumination is directed. From these two images of the scene, color errors are determined and reduced or eliminated. The tunable filter of the present invention does not require any moving parts for the filter to produce the two states.

The filter is thin, inexpensive, has high transmission, and switches rapidly between states (0.1 ms or less). It can be constructed using only a single liquid crystal cell. In a preferred embodiment, the imaging sensor is a mosaic-type CMOS detector with the capability to store multiple exposures on-chip for subsequent read-out. This enables taking two exposures in rapid time-series (under 0.1 ms between images) so color blur is minimized and there is no difficulty utilizing flash lighting.

The color detector can be a type which conventionally records a scene in one image, or a specialized time-sequential type that normally requires two or more images. In the first case, the detector is a conventional (mosaic) detector such as is used in digital cameras and video equipment, or an assembly of three detectors and a trichroic prism, or a tricolor linear detector such as are widely used in scanners. These types of detectors can be used to take high-fidelity color images when used in concert with the two-state tunable filter, in accordance with this invention.

In the other case, the detector can be a specialized detector which affords color selectivity by voltage control of a bias layer on the detector. Three exposures are taken, and each has somewhat different spectral response. From the three exposures, a color image is derived. When such a detector is coupled with a two-state tunable filter, improved color is attained. Typically, the filter is used to sharpen up the color selectivity so that each exposure corresponds more closely to an additive primary, with less cross-talk that would need to be corrected by digital processing. In one embodiment, the filter transmits either green or magenta light, and its state is switched in coordination with the biasing and readout of the detector. By making the three color states more distinct in this way, there is less need for cross-talk corrections that add noise to the final image. The filter can also render the spectral response of the raw exposures to be closer to a combination of the tristimulus X, Y, and Z functions, improving color fidelity.

For some applications, it is preferable that the filter be clear in one of its states, so the overall arrangement has a “compatibility” mode in which it functions like present-day equipment, and produces images of merely ordinary color fidelity in a single exposure. This may be useful for focusing, composition, or the like. High color fidelity images are then acquired by taking multiple exposures, with the filter in each of its two states, and calculating the proper color from the resulting images.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

In the following Figures, where like numerals are used to denote like elements:

FIG. 1 depicts the present invention 10, including a mosaic-type detector 11, a tunable filter with two states 12, and control electronics 13.

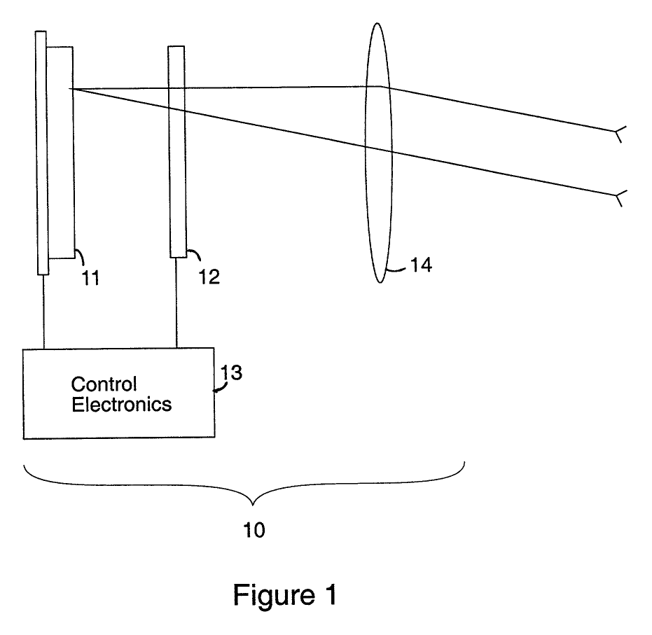

FIG. 2 depicts another embodiment of the present invention 10′, including a detector whose spectral response is varied by electronic means 21, a tunable filter with two states 12′, and control electronics 13.

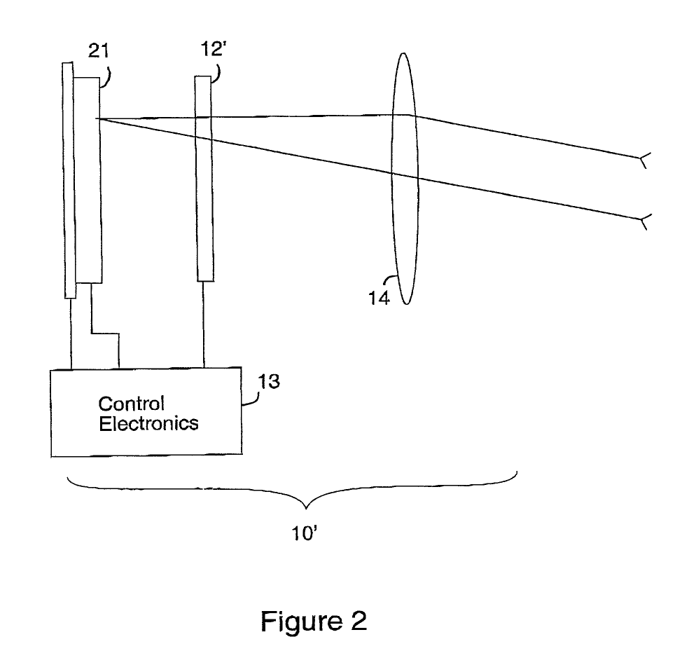

FIG. 3 depicts the spectral response of the three color channels in a Sony ICX085AK mosaic-type detector, along with the least-squares error fits to the detector response made from linear combinations of the tristimulus functions.

FIG. 4 depicts the actual tristimulus functions along with a least-squares fit to these based on the three color channels of the Sony ICX085AK detector.

FIG. 5 depicts the spectral response of a Silicon Vision CASEAR detector whose spectral response is varied by electronic means 21, in each of three states 51, 52, and 53 corresponding most nearly to red, green, and blue. Also shown are least-squares error fits to the detector response made from linear combinations of the tristimulus functions.

FIG. 6 depicts the construction of a filter 60 suitable for practicing the present invention.

FIG. 7 depicts the spectral response of transmission vs. wavelength for such a filter, in each of its states. One of the states 71 is nearly clear, i.e. its transmission is high and nearly constant as a function of wavelength, while state 72 is substantially filtering.

FIG. 8 depicts the construction of another filter 60′ suitable for practicing the present invention.

FIG. 9 depicts the spectral response of transmission vs. wavelength for such a filter in each of its states 91 and 92. The states are nearly complementary, i.e. except for fixed absorption losses, they sum to unity.

FIG. 10 depicts the spectral response functions of a preferred embodiment of the invention, in each of the color channels for each of the filter states.

FIG. 11 depicts the actual tristimulus functions, along with the best match to these derived from the spectral response of the preferred embodiment in FIG. 10.

FIG. 12 depicts the spectral response functions 121, 122, and 123 of another preferred embodiment, using a first filter state for blue and red, and a second filter state for green.

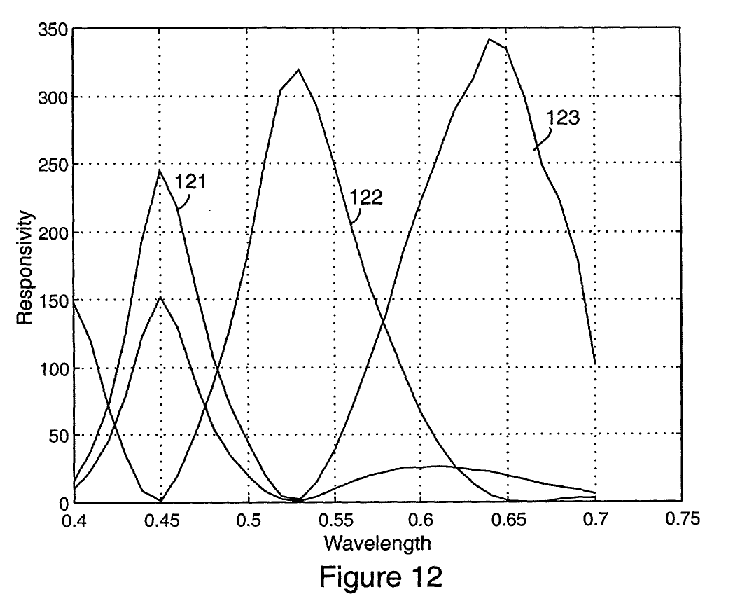

FIG. 13 shows an alternative embodiment 10″ where the filter is placed between the source of illumination 141 and the object to be imaged 142, rather than between the object and the detector.

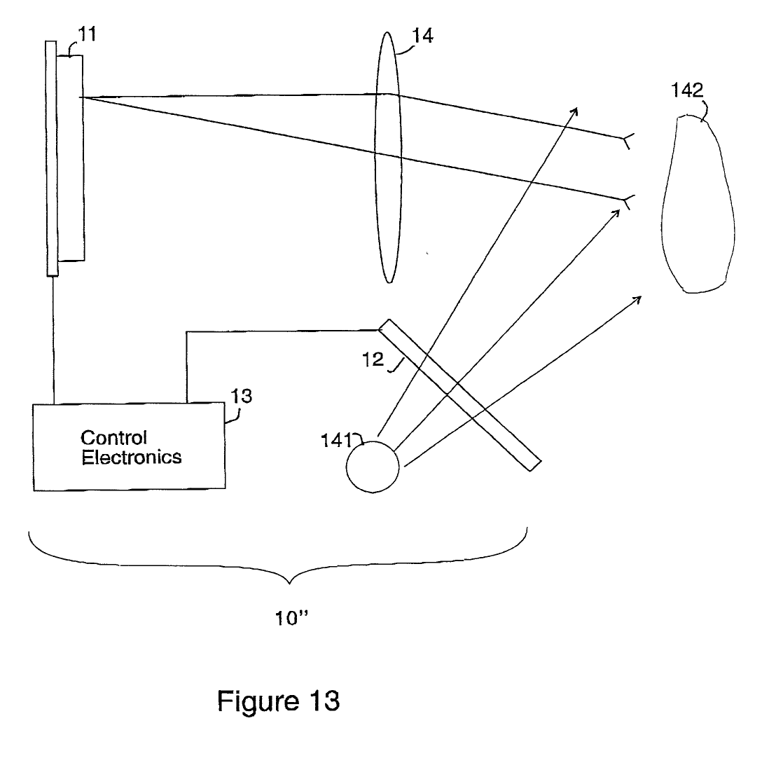

### DETAILED DESCRIPTION OF THE PRESENTLY PREFERRED EMBODIMENTS

In this description, certain terms are used interchangeably. In particular, the terms “sensor” and “detector” are both used to denote a photodetector that provides at least a one-dimensional image of a scene, and more commonly, a two-dimensional image. It is specifically intended that this term include detectors comprising three photodetectors and a trichroic prism in the arrangement widely used for medical imaging and pro-level video equipment. The terms “retarder” and “waveplate” are used to denote an optical retarder that has a certain retardance which may further be described in terms of the amount of retardance. For example, a λ/2 waveplate is a retarder which exhibits an optical retardance of one half wave for light of a specified wavelength, or when no wavelength is specified, for light generally within the operating range of the system. The term “light” is used to denote visible light, infrared light, and ultraviolet light. Although the examples are drawn from the realm of visible light with the goal of matching the tristimulus curves that embody the human eye's response, comparable systems can be constructed for other spectral ranges, where the goal is to matches some other set of response curves.

Throughout this description, reference is made to optical retarders. These can be made of any material or structure that provides the desired retardance, and it is common to use oriented polymer films such as mylar, polyvinyl alcohol (PVA), polypropylene, polycarbonate, and so on. These are commercially available from Nitto Denko America (Fremont, Calif.), Sanritz (San Jose, Calif.), or Polatechno (Tokyo, Japan), or Polaroid (Norwood, Mass.). However, other materials can also be used if this is preferred for any reason such as convenience, economy, ease of fabrication, or size. Exemplary alternatives include crystalline materials such as quartz, calcite, lithium niobate, and mica; form-birefringent glass from Corning (Corning, N.Y.); photo-oriented films and polymers; layers of liquid crystal material or liquid crystal polymer material; and combinations of these.

Similarly, throughout this description when reference is made to a switchable or tunable retarder, it can be a nematic liquid crystal cell such as a ‘pi’ cell, as is known to those familiar with the liquid crystal art. Or, a flat-field variable retardance cell can be employed. Or, one can use an electrically-controlled birefringence (ECB) type cell that incorporates liquid crystal material with a negative dielectric constant and molecular alignment normal to the substrates in the absence of an applied field; or it can be a hybrid-aligned cell which has homeotropic alignment at one substrate face and homogeneous alignment at the other. In short, it may be any cell which can produce the desired optical effect of a variable retardance along a specified axis. All the above means and others will be familiar to those skilled in the liquid crystal art.

When polarizer material is used, it may be any type that has the desired mixture of properties including size, cost, and optical performance. Frequently, it is convenient and suitable to use sheet dichroic type material such as Nitto Denko NPF-1425DU. Commercial materials of sheet dichroic polarizer include Nitto Denko (Fremont Calif.), Sanritz (San Jose, Calif.), International Polarizer (Marlboro, Mass.), and Polaroid (Norwood, Mass.). If it were preferred, one could employ alternative types of polarizer such as prism-type beamsplitters. These are available from Meadowlark Optics (Longmont, Colo.) or Karl Lambrecht (Chicago, Ill.).

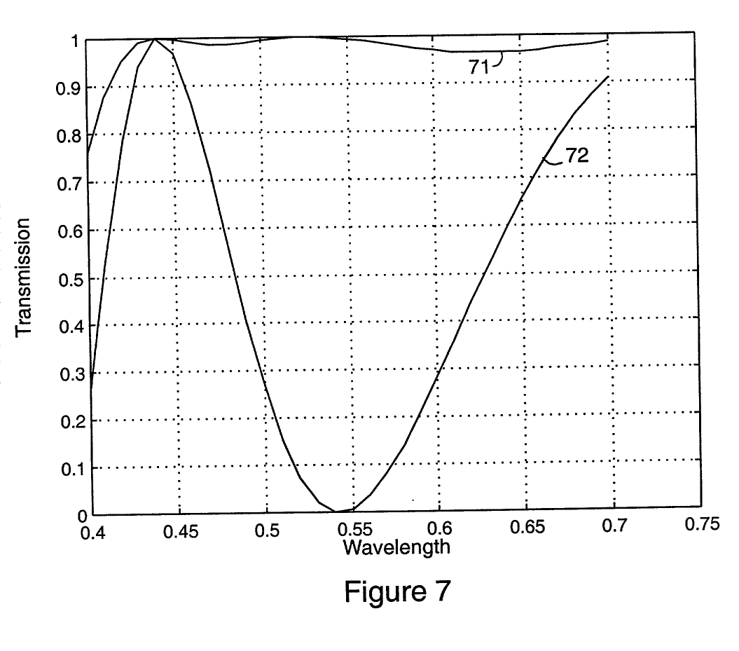

In the first preferred embodiment, one state 71 of the filter is nominally clear and has high transmission for all wavelengths of light, as shown in FIG. 7. The other state 72 of the filter has a spectral filter action that is chosen to enable improved color imaging. Suitable filters are described in U.S. Pat. No. 5,892,612, “Tunable optical filter with white state”, the contents of which are incorporated by reference. While only one embodiment of such a filter is described herein, any tunable filter of this or any other type would be suitable for the practice of the present invention.

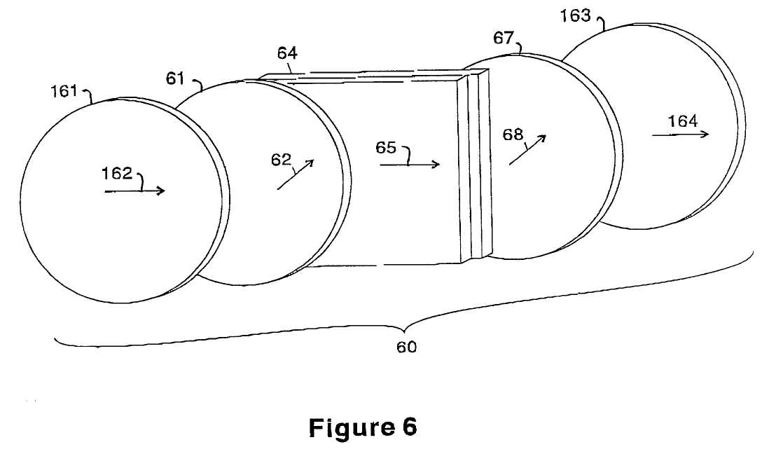

A diagram of such a filter is shown in FIG. 6. It consists of the following elements in optical series: entrance polarizer 161 with its transmission axis 162 at 0°; fixed retarder 61 of retardance R with its fast axis 62 at 45°, variable retarder 63 that is switchable between substantially zero retardance and λ/2 retardance and has its slow axis 64 at 0° orientation; a second fixed retarder 67 of retardance R with its fast axis 68 at 45°; and exit polarizer 163 with its transmission axis 164 at 0°. When variable retarder 63 is a half-wave plate, fixed retarders 61 and 67 cancel, and the net result is a high transmission for all wavelengths of light. When variable retarder 63 exhibits low retardance, retarders 61 and 67 sum, and the effect is that of a single retarder with value 2R, oriented at 45°. This produces a spectrally varying transmission, as is understood by those familiar with the art.

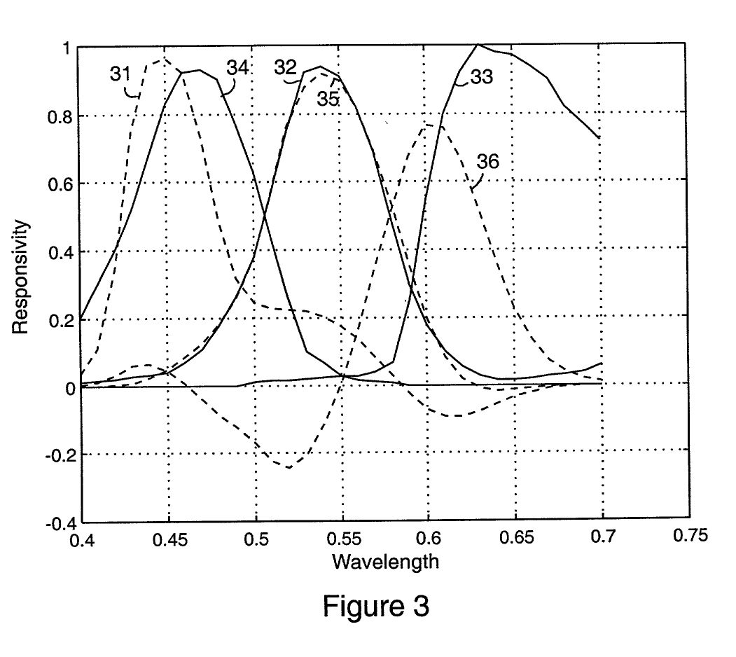

For a detector, the first preferred embodiment uses a mosaic-type CCD detector such as the ICX085AK from Sony. This chip has color filters arrayed in a Bayer pattern, from which it may be used to generate color images according to the methods of the prior art. However, the color response attained this way is not ideal. The actual response is shown in FIG. 3, where the blue channel sensitivity is indicated by curve 31, the green channel sensitivity is indicated by curve 32, and the red channel sensitivity is indicated by curve 33. These may be compared with the best fit to these curves from combinations of the three tristimulus curves, which are depicted by curve 34, 35, and 36, respectively. From a detector having these, or any other linear combination of the tristimulus curves, one can determine color with perfect fidelity. Yet as this Figure shows, there is significant divergence between the actual color channels and the nearest fit based on tristimulus functions.

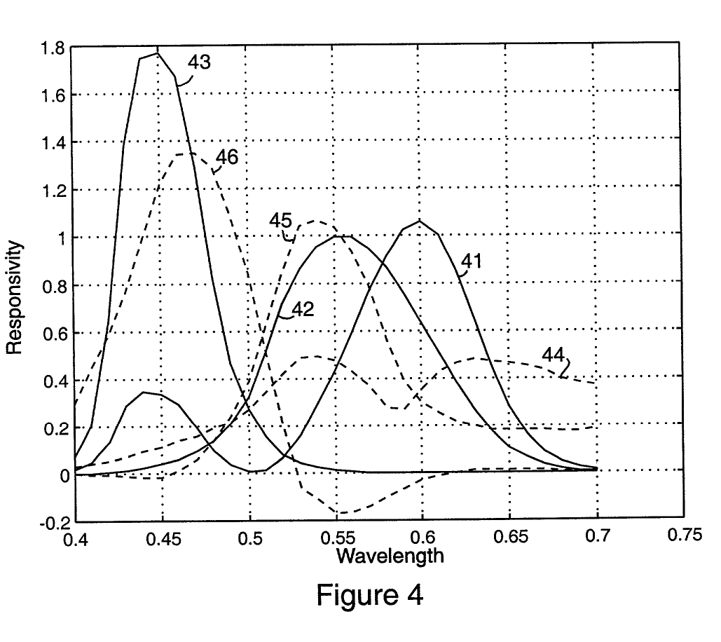

Illustrating this, FIG. 4 shows the tristimulus functions X, Y, and Z, as 41, 42, and 43 along with the best least-squares fit to these from the actual red, green, and blue channel responses as 44, 45, and 46. To the extent that the actual curves fail to form a basis vector set for the tristimulus functions, there is inherent color distortion and error. It is clear that, used on its own according to the prior art, this sensor exhibits considerable color error across the entire visible range.

In terms of color error, the Sony device is typical of present-day color detectors, as all such detectors have these same defects to a greater or lesser degree. The degree of color error may be estimated, at least in a rough sense, by calculating the sum of the squared error between actual and best-fit tristimulus curves. The result is a color error index of 27.19, based on measuring the squared error every 10 nm from 400 to 700 nm.

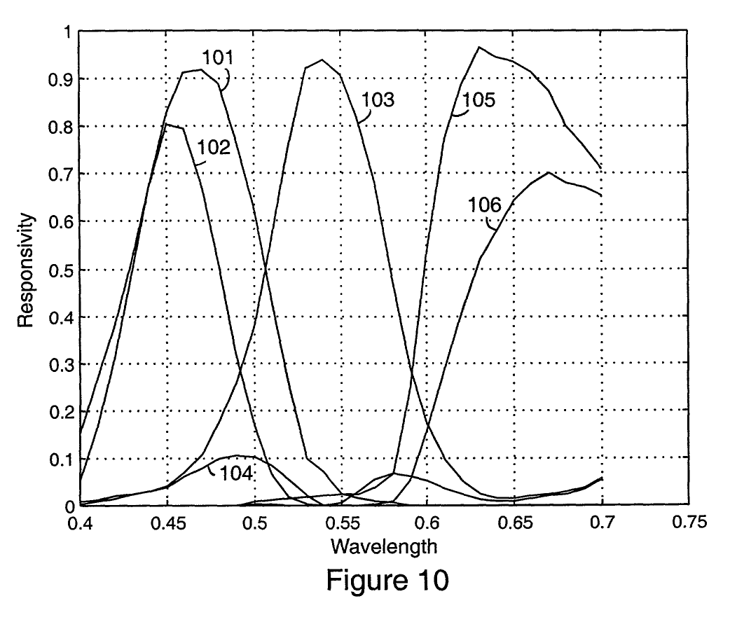

In the first preferred embodiment of the invention, the detector is used with the filter of FIG. 6, where retarders 61 and 67 are NRZ film from Nitto Denko with a retardance R=1λat 440 nm. The optical transmission in the filtering state is high transmission at 440 nm, dropping until extinction is achieved at 545 nm, then increasing transmission with wavelength, up to the end of the visible range. This is shown in FIG. 7 as 71 in the nominally clear state, and as curve 72 in the filtering state. The net transmission of the system (detector plus filter) is shown in FIG. 10, for both the nominally clear and filtering states. The blue response is shown as 101 and 102, the green response as 103 and 104, and the red response as 105 and 106, respectively. These may be calculated as the product of the detector response shown in curves 31, 32, and 33, times the filter response shown as 71 and 72 for clear and filtering states, respectively.

Note that the overall signal level and spectral shapes are greatly altered by the optical filter, as expected. The distribution of energy in the blue band shifts from 101 to 102 as the filter is switched from the clear to the filtering state. This effectively shifts the sensitivity peak towards shorter wavelengths. Similarly, the red is shifted from 105 to 106, i.e. toward longer wavelengths, when the filter is in the filtering state. Intuitively, one can see that this provides information about two sub-ranges of the blue signal, and similarly of the red. While green is nearly extinguished in the filtering state, the residual signal shown as 104 is two ‘wings’ which indicate less saturated greens, in contrast with the unfiltered green signal shown as 103 that most heavily weights saturated greens.

In operation, one takes an image with the tunable filter in its nominally clear state 71, and then takes a second image with the filter in the state where it exhibits a desired filtration action, such as that shown as 72. From the two images, it is possible to determine the color with enhanced fidelity, since there is a great deal more color information available from the combination of the filter and detector together, than from the detector alone.

The following describes one way to perform the color fidelity enhancement, and others will be apparent to those skilled in the art of color science. The goal is to derive a color balancing matrix M that expresses the output color in terms of the six color images obtained by the inventive system (R,G,B with the filter in the clear state, and R,G,B with the filter in its filtering state). Specifically, one seeks the 3×6 matrix M that is used to calculate the output image as:

O=M*I [1]

where O is the output RGB image represented as a 3×1 column vector, I is the input set of raw exposures represented as a 6×1 column vector containing the 3 color channels in each of the two filter states. This equation is used to calculate the color at every point in the image.

For a system with ideal color reproduction, one can write

O=C⁻¹*T [2]

where T is a column vector of the tristimulus values at a given point, C⁻¹ is the inverse of the matrix C containing the (x, y, z) chromaticity of the three output primaries. That way, when the image is displayed,

D=C*O=C*(C⁻¹*T)=T [3]

so the displayed image has the same tristimulus values as the object itself and is visually identical to it.

In order to derive M, one first calculates the fit matrix F defined by

F=TS/IS [4]

whereby one can write

TS=F*IS [5]

In these equations, IS is the 6×31 matrix containing the spectra for the six channels (three detector channels in each of two filter states), measured at 31 spectral points from 400 to 700 nm by 10 nm steps. Similarly, TS is the 3×31 matrix containing the tristimulus weighting functions X, Y, and Z at each of 31 spectral points from 400 to 700 nm by 10 nm steps. This equation expresses the spectral response of the sought-after tristimulus curves in terms of the spectral response of the detector and filter.

F is a 3×6 matrix whose i-th row contains the coefficients for a least-squares fit to the i-th tristimulus function weighting spectrum (X, Y, or Z) in terms of the input spectra. Physically, it indicates the weighting of the various input channels (red, green, and blue, in each of two filter settings) from which one may best construct a tristimulus image of the scene. Of necessity, F is over-determined, since a given row of F seeks to construct a 31-point tristimulus weighting function as a linear combination of six 31-point input spectra. For each of the tristimulus functions, it seeks to satisfy 31 output variables but has only six degrees of freedom. Thus equation [4] is solved in a least-squares sense, and F represents a best fit to the tristimulus functions, rather than a perfect solution. Techniques for this are well known in the mathematical art, and commercial software such as Matlab from The Mathworks (Natick, Mass.) provide functions for doing just this task. If desired, one may prefer to solve for the value of F that minimizes a desired error function rather than minimizing the simple sum of squared errors. For example, one may wish to minimize the sum that results after applying a spectral weighting function to the squared error. Use of such weighting functions, and the techniques for solving for F under such constraints, are known to those skilled in the art.

Combining equations [1], [2], and [5], one can write:

O=M*I=C⁻¹*T=C⁻¹*F*I [6]

from which it is evident that

M=C⁻¹*F [7]

Thus, upon determining the spectral response of the detector and filter, one can calculate the best-fit matrix F to convert input images into tristimulus color space. This is mapped to an output color space by the matrix inverse of the output primary chromaticities.

M is specific not only to the detector and filter employed, but to the output primaries used. Often these will be the NTSC primaries, although other primaries can be employed. And, since the images obtained by this system are true in colorimetric terms, one can transform from a given primary to another by a linear algebraic transformation simply by using a different value for C (and hence, C⁻¹). Techniques for such transformations between color spaces are well-known in the art of color management and rendering. Significantly, there is no loss of color fidelity in this case, because the image being transformed does not favor or weight one color or spectral region improperly.

The work in deriving M involves a fair amount of measurement and calculation, but needs only be performed once, when the system is designed. Once M is known, the processing is simply that shown in equation [1]: assemble the R,G, and B signals obtained under each of the two filter settings into a six-element column vector, and multiply this vector by M to produce the output color image. This can be achieved by low-level digital signal processing chips, and can be accomplished at high speed.

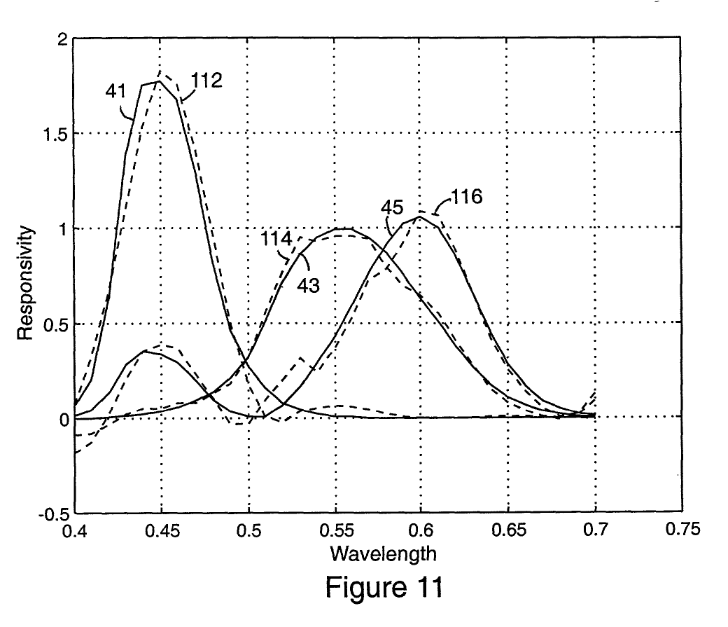

The result is significantly reduced color error, as shown in FIG. 11. This depicts the actual system response, along with linear fits from the tristimulus functions, which correspond to perfect color reproduction. The error is significantly reduced compared with the Sony sensor alone. When the color error index is calculated using the same criterion of summing the squared error between the tristimulus functions and the best filter match to these curves, the result is 0.598—an improvement in excess of 45:1.

A second preferred embodiment consists of the same filter, used with a detector comprising three CCD sensors and a trichroic prism, together with acquisition and color analysis electronics. Because a different sensor is used, this system will have a different set of spectral responses for both the filtered and unfiltered state, and one will need to recalculate the matrix M in the fashion described above, or some equivalent process.

In yet another preferred embodiment, the detector is a mosaic type, and incorporates circuitry to store two exposures for subsequent readout. This enables taking the two exposures in extremely rapid time-sequence, to essentially eliminate color blur.

Those skilled in the art will realize there are many approaches which can be taken in selecting a filter response to enhance the calorimetric accuracy of the image. The filter need not express the particular filter response that was used in the above embodiments, and indeed other designs may be equally good or superior in some cases. To arrive at a suitable filter design, one may simply try various filter approaches and compare the color error that results from each. This is a valid way to choose a filter design. This can be done using numerical models or experimental data according to one's preference. It is not always necessary to provide perfect linear construction of the XYZ tristimulus response; it is the goal of the present invention to provide a markedly better image than is possible with an RGB detector alone. But for the most precise work, the detector response must be understood in detail, and the filter constructed to provide a set of responses which enable rigorous matching to the XYZ curves, using modeling or experimental methods as described above to assess the results. U.S. Pat. No. 5,479,524 by Farrell et. al. describes a method for determining which filter is best from amongst a predetermined bank of filters, for purposes of reducing color error. The approach described therein for selecting between predetermined filters in a scanner, may also be used when determining which pair of filter responses is best for use in the present invention.

In the preferred embodiments described above, the filter has a nominally clear state. This has many benefits, such as enabling a ‘compatibility’ mode where the filter is essentially passive, and remains in the clear state. When speed is paramount, such a mode enables use of the detector system in a simple RGB mode (albeit with the color fidelity limitations of the existing RGB detector art). However, when improved color response is sought, a second image is taken and the high-fidelity color image is calculated. The switching time of liquid crystal elements can be 1 ms or less, enabling rapid scanning, or image acquisition at video-or-faster rates. Nonetheless, the speed in high-fidelity mode is reduced simply by the need for acquiring and processing two RGB images, and it can be a benefit to disengage the filter; for this reason many applications will favor the use of a filter with a clear state.

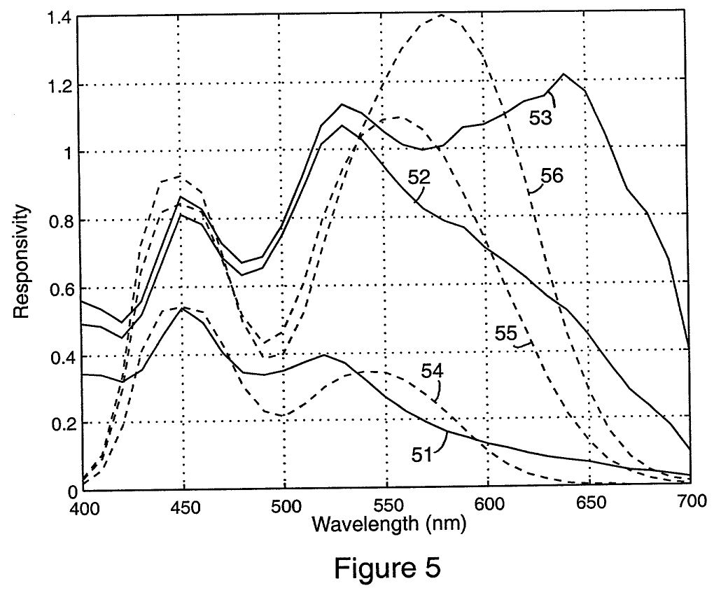

Other systems will favor a filter with two spectrally-filtering states. An exemplary system of this type utilizes a sensor such as the CAESAR detector developed by Silicon Vision (Siegen, Germany). This is a CMOS chip onto which an amorphous silicon photodiode array is deposited. By various bias voltages to the detector, one can greatly change its spectral response. FIG. 5 shows the detector response with bias voltages of 0V, 4V and 1V. From the images taken using three such images, one can produce color images.

CAESAR incorporates an integral application-specific integrated circuit (ASIC) which can store readings at every pixel, on-chip, at high speed. This is a powerful benefit in the present context. Conventional detectors require that the chip be read out before a second image may be taken. This limitation is overcome by the Silicon Vision approach. Thus, three images can be taken in rapid succession, with the bias voltage changed between exposures, to yield a color image with full spatial resolution (no mosaic pattern to degrade resolution or introduce moire effects).

However, the color quality of the images is very poor. There are two key reasons for this: first, the spectral response curves of the detector are broad and not as well-distinguished from one another as would be optimal. In order to construct “RGB” images, one must take steps to exaggerate the differences between the images. Typically, this means using a 3×3 matrix to convert the raw image data for each pixel to RGB values. Ideally, from a signal-to-noise perspective, this would be a 3×3 identity matrix, where the output data is simply one of the three raw images. This is rarely achieved in practice. But the off-diagonal terms must be very large to produce good color balance using the bias-controlled detector, which means that the inevitable noise in the detector or digitizer, is greatly amplified and produces a very grainy appearance.

The second reason is that the color set defined by the spectra in the three images, is quite different from the XYZ standard color responses, or of any linear combination of these. So it is impossible to produce color images that accurately reproduce the diverse range of colors found in the natural world. If the camera is optimized for some colors, others will reproduce poorly.

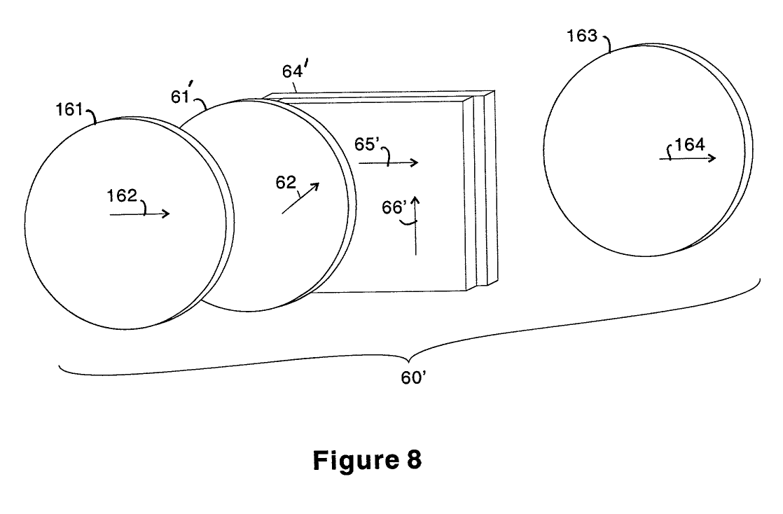

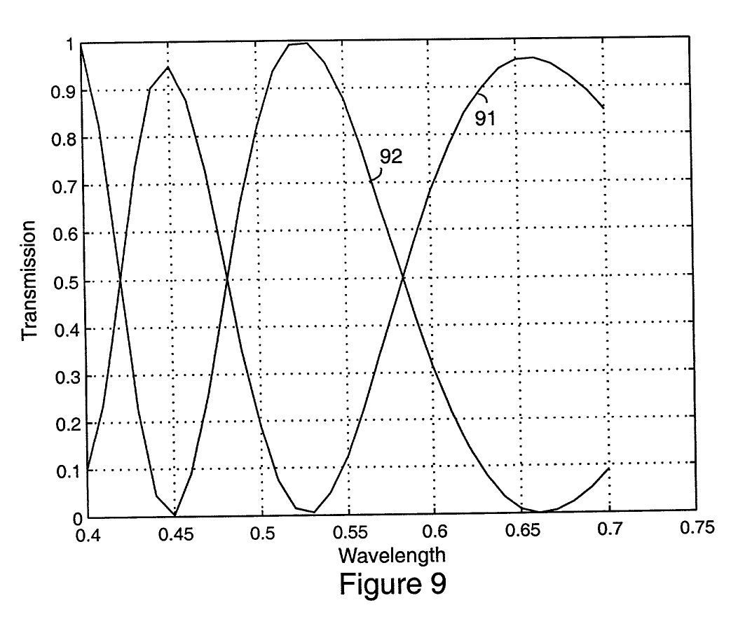

Another preferred embodiment of the present invention solves both these problems. It utilizes a filter with two states, neither of which is a clear state, in concert with the Silicon Vision detector. It is used to enhance the color differentiation of the detector, so the three images are more distinct in their spectral response, and to render the response more nearly a linear combination of the tristimulus curves. The filter is pictured in FIG. 8. It consists of a retarder 61′ oriented with its fast axis 62 at 45, having 2 retardance at 525 nm, in series with a TN cell 64′ having its buffing axes 65′ and 66′ at 0 and 90, placed between parallel polarizers 161 and 163 having transmission axes 162 and 164 at 0. Such an assembly has high transmission at 525 nm, with minima at 450 and 650 nm, when the TN cell is driven; it has high transmission at 450 and 650 nm, and low transmission at 525, when the TN cell is undriven. These are shown as transmission curves 91 and 92 in FIG. 9.

The filter described above, set with its state with peak transmission at 450 and 650, and minimum transmission at 525 nm, is used to take the exposures with 0V and 4V bias. The filter acts to greatly favor the red and blue spectral components of the scene, and to greatly attenuate the green components. Thus, the 0V and 4V images taken by the detector have spectral responses which are much more nearly matched to the conventional B and R images.

The filter is then switched to the state with peak transmission at 525 nm and minimum transmission at 450 and 650 nm. This is used to take the exposure with 1V bias. The filter greatly favors the green spectral components of the scene, and to attenuate the red and blue components. The overall system (filter plus detector) has a response which is much more nearly matched to a conventional G image.

This system is uniquely well-suited to digital still photography, since the detector is capable of reading three exposures rapidly (during a single flash exposure). Also, the tunable filter can switch from the off-state to the on-state in a time of approximately 100 microseconds. The liquid crystal tunable filter proposed herein has inherent advantages in terms of simplicity, physical size, cost and optical transmission, relative to more complex filters that switch R-G-B. Only a single liquid crystal element is used, and low-cost, high-transmission film layers.

Black and white images, if necessary, can be obtained in various ways, such as leaving the detector at a bias of 1V and switching the filter at the mid-point of an exposure.

In yet another preferred embodiment, the TN cell may be a first-minimum type with its minimum optimized for 525 nm.

In yet another preferred embodiment, a variable retardance pi cell oriented with its crystal axis at 45° is used as the switch element instead of the TN cell.

Video and HDTV systems can also be constructed when one uses faster liquid crystal switch elements. When a variable retardance switch is used instead of a TN cell switch, switch times of 60 microseconds (off-on) are possible, and 600 microseconds (on-off). If further speed improvements are necessary, they can be achieved using ferroelectric switches. An achromatic switch that incorporates one or more fixed retarders for compensation purposes will work as well. All these are known to those familiar with the art. Means for incorporating these switches in to the clear-state filters are described in U.S. Pat. No. 5,892,612, and their use with retarders or retarder stacks is well known in the art.

Any liquid crystal switch may be used provided that it serves the optical purposes of the invention, namely to select between two optically different filter states, at least one of which must be an optically filtering state, and one of which may be a filtering state or a clear state.

Other types of electro-optic switches or filters may be used which do not incorporate liquid crystal elements at all, provided they yield a switchable filter action.

It is equivalent to place the filter between the detector and the scene, or between the source of illumination and the scene. The former approach is more practical when imaging outdoor scenes and the like, where the illumination is not easily controlled; while the latter may be useful when the illumination comes from a single compact source. Placing the filter proximate to the illumination source rather than proximate to the detector is particularly apt when working with fiber optic illumination sources, for machine vision, inspection, medical imaging, endoscopy, and the like.

Thus various embodiments and components have been shown for constructing this invention, and these may be used singly or in combination, or with other elements known in the arts of optical design, color science, and liquid crystal cell design. It is understood that these and other such combinations, substitutions, and alternative embodiments may be undertaken according to the requirements and materials at hand without deviating from the spirit of the invention, the scope of which is to be limited only by the claims appended hereto.

All references cited herein are incorporated by reference.

I claim:

1. An imaging system to capture an accurate color image of a scene when illuminated by light, comprising in optical series
a tunable filter tunable between a first state wherein light transmitted by the filter has a first spectrum and a second state wherein light transmitted by the filter has a second spectrum different from the first spectrum; and
a color detector that captures an image of the scene by recording the light transmitted through the filter when the filter is in the first state, and then recording the light transmitted through the filter when the filter is in the second state.

2. The imaging system of claim 1 wherein in one of the first and second states the tunable filter transmits incident light of all wavelengths to a substantially equal degree.

3. The imaging system of claim 1 wherein in both the first and second states of the tunable filter at least some of the incident light is spectrally-filtered.

4. The imaging system of claim 3 wherein the first and second states of the tunable filter transmit colors that are substantially complementary to each other.

5. The imaging system of claim 1 wherein the tunable filter comprises a nematic liquid crystal cell.

6. The imaging system of claim 1 wherein the tunable filter comprises a flat-field variable retardance cell.

7. The imaging system of claim 1 wherein the tunable filter comprises an ECB type cell.

8. The imaging system of claim 1 wherein the tunable filter comprises a ferroelectric liquid crystal cell.

9. The imaging system of claim 1 wherein the color detector is a CMOS detector.

10. The imaging system of claim 1 wherein the color detector captures a two-dimensional image of the scene.

11. The imaging system of claim 1 wherein the color detector is selected from the group consisting of a mosaic-type detector, an assembly of a trichroic prism and three detectors, and a tricolor linear detector.

12. The imaging system of claim 1 wherein the color detector has a spectral response that is dependent on the bias voltage applied to the detector.

13. The imaging system of claim 1 wherein the tunable filter is disposed between the light that illuminates the scene and the scene whereby the tunable filter is filtering the light that illuminates the scene.

14. The imaging system of claim 1 wherein the tunable filter is disposed between the scene and the detector whereby the tunable filter is filtering the light received from the scene.

15. An endoscopic system to capture an accurate color image of a scene when illuminated by light, comprising in optical series
a tunable filter tunable between a first state wherein light transmitted by the filter has a first spectrum and a second state wherein light transmitted by the filter has a second spectrum different from the first spectrum; and
a color detector that captures an image of the scene by recording the light transmitted through the filter when the tunable filter is in the first state, and then recording the light transmitted through the filter when the tunable filter is in the second state.

16. The endoscopic system of claim 15 wherein the first and second states of the tunable filter transmit colors that are substantially complementary to each other.

17. The imaging system of claim 15 wherein in one of the first and second states the tunable filter transmits incident light of all wavelengths to a substantially equal degree.

18. An endoscopic system to capture an accurate color image of a scene when illuminated by light, comprising in optical series
a filter wheel capable of switching between a first filter wherein light transmitted by the first filter has a first spectrum and a second filter wherein light transmitted by the second filter has a second spectrum; and
a color detector that captures an image of the scene by recording the light transmitted by the first filter, and then recording the light transmitted by the second filter.

19. The endoscopic system of claim 18 wherein the first and second states of the first and second filters transmit colors that are substantially complementary to each other.

20. The endoscopic system of claim 18 wherein in one of the first and second filters transmits incident light of all wavelengths to a substantially equal degree or transmits all incident light.

21. A method to capture an accurate color image of a scene when illuminated by light, comprising
passing the image through a tunable filter tunable between a first state wherein light transmitted by the filter has a first spectrum and a second state wherein light transmitted by the filter has a second spectrum different from the first spectrum; and
recording the light transmitted through the filter with a color sensor when the tunable filter is in the first state, and then recording the light transmitted through the filter with the color sensor when the tunable filter is in the second state.

22. A method to capture an accurate color image of a scene when illuminated by light, comprising
passing the light that illuminates the scene through a tunable filter tunable between a first state wherein light transmitted by the filter has a first spectrum and a second state wherein light transmitted by the filter has a second spectrum different from the first spectrum; and
recording the light received from the scene with a color sensor when the tunable filter is in the first state, and then recording the light received from the scene with the color sensor when the tunable filter is in the second state.

23. The imaging system of claim 1 wherein the tunable filter is a switchable optical birefringent filter responsive to incident light in a polarization state comprising:
a first optical retarder having an optical axis and a first action on the polarization state of incident light passing through the first retarder;
a second optical retarder disposed in optical series with said first retarder for receiving light that has passed through the first retarder and having an optical axis and a second action on the polarization state of the received light passing through the second retarder; and
a switch disposed between the first optical retarder and the second optical retarder operable for varying the filter response between a first operating state in which the filter transmits without significant alteration to the polarization state substantially all of the incident light within a predetermined range of wavelengths and a second operating state in which the filter produces a predetermined spectral variation of the incident light in its passing through the filter by changing the polarization state of the light received by the second retarder.

24. The imaging system of claim 1 wherein the color at each point of the image is calculated by recording the signal levels at that point in each image, as obtained with the tunable filter in each of the first and second states, and combining the signal levels in predetermined proportions to produce the final color value for that point.

25. The endoscopic system of claim 15 wherein the color at each point of the image is calculated by recording the signal levels at that point in each image, as obtained with the tunable filter in each of the first and second states, and combining the signal levels in predetermined proportions to produce the final color value for that point.

26. The endoscopic system of claim 18 wherein the color at each point of the image is calculated by recording the signal levels at that point in each image, as obtained with each of the first and second filters, and combining the signal levels in predetermined proportions to produce the final color value for that point.

27. The method of claim 21 wherein the color at each point of the image is calculated by recording the signal levels at that point in each image, as obtained with the tunable filter in each of the first and second states, and combining the signal levels in predetermined proportions to produce the final color value for that point.

28. The method of claim 22 wherein the color at each point of the image is calculated by recording the signal levels at that point in each image, as obtained with the tunable filter in each of the first and second states, and combining the signal levels in predetermined proportions to produce the final color value for that point.
